(19) United States
(12) Patent Application Publication
(10) Pub. No.: US 2006/0222825 A1
(43) Pub. Date: Oct. 5, 2006

(54) Method for use of a polymer coated paper or board as printing substrate, a printed product obtained by the method and use of a coating

(76) Inventors: Sami Haakana, Lavatie (FI); Risto Vesanto, Koivuniementie (FI)

Correspondence Address: BIRCH STEWART KOLASCH & BIRCH, PO BOX 747, FALLS CHURCH, VA, 22040-0747, US

(21) Appl. No.: 10/552,436

(22) PCT Filed: Apr. 7, 2004
(86) PCT No.: PCT/FI04/00212

§ 371 Date: Jun. 9, 2006

(30) Foreign Application Priority Data
Apr. 10, 2003 (FI) 20030541

(51) Int. Cl. B41M 5/00

(52) U.S. Cl. 428/195.1

(57) ABSTRACT

The invention relates to a method for using a polymer-coated paper or board as a printing substrate, to the printed product thus obtained and to the use of the coating. The invention relates to repeated use of the printing substrate, so that the printing ink is removed with a solvent from the surface that has been printed once, and the printing substrate thus cleaned is used for reprint. In accordance with the invention, the printing surface is formed of polysiloxane, to which polyester or styrene acrylate-based toners attach so as to be irremovable by mechanical means, yet removable by washing with a suitable solvent, such as acetone, for instance. A polysiloxane-coated paper or board is suitable especially for electro-photographic print with a dry toner, which can be fixed to the printing surface by fusion.

The invention relates to a method for using a polymer-coated paper or board as a printing substrate. The invention also comprises the use of the printed product obtained by the method and of a coating on paper or board as a printing surface.

Nowadays printed products that used to end up as waste at dumps are reclaimed principally in the form of recycled paper or similar recycled products. Polymers can be separated from polymer-coated printed papers and boards used primarily as packaging material in the step of repulping recycled fibres, being subsequently usable as a fuel.

Polymer-coated papers have been produced by printing the paper or board by usual printing methods before coating with a transparent polymer layer, the print remaining within the layer structure of the finished product. This procedure has the drawback of the printing step being bound as an integrated part of the process for preparing the material. Substantially more flexible production is achieved by using previously coated paper or board as the printing substrate. There are e.g. known methods for electro-photographic printing of polymer-coated paper or board, cf. e.g. U.S. Pat. No. 5,741,572, although these have involved problems related to fixing of the printing ink and to print quality, depending on the electric properties of the materials. Different polymer qualities have been noted to be well suitable for various digital prints by means of dry toner formulations.

All of the techniques for producing polymer-coated printed products mentioned above are based on a disposable printing substrate. Even in recycling processes, the material is decomposed, the fibres are recovered and prepared as recycled paper or board, which can be subsequently reused as a printing substrate during printing. A technique allowing repeated use of the printing substrate as such would signify a crucial improvement to this technique. In that case, it should be possible to remove the print from the printing surface by simple means without damaging the printing surface itself in any way.

There are a number of known attempts in literature to solve the problem mentioned above. DE patent application 19958258 A1 describes a polymer laminate or a polymer-coated water-repellent paper used as a printing substrate, from which the printing ink can be removed by expanding the coating in water, followed by mechanical brushing. Subsequently the printing surface requires treatment by a surfactant or a dispersion of finely divided particles, which again makes the material fit for use in a copying or printing machine. JP patent specification 4091298 discloses removal of printing ink from a fibre-based printing paper by immersing the paper in a solution containing a surfactant, by ultrasound washing of the paper and by finally drying the paper with hot air. DE patent application 4132288 A1 describes a solution with a different starting point, which is not based on the use of printing ink, but produces print on the coating of printing paper by means of a regenerative colour change reaction produced by laser. Thus the print can be faded out by laser or heat, upon which the material is reusable.

The purpose of the present invention is to provide a simpler solution to the problem of a reusable printing substrate, the solution being based on the removal of the printing ink from the substrate between service cycles by washing with a solvent, without any other operations. The invention is based on polysiloxane-coated paper or board, whose printing qualities have proved good in tests and from which the printing ink has been easily removed without damaging the printing surface formed of polysiloxane, or without deteriorating its reprinting qualities. The method of the invention is thus characterised by the fact that a printing substrate, whose polymeric printing surface is formed of polysiloxane, is repeatedly used by removing with a solvent the printing ink from a printing surface already once printed and by subsequently reprinting the surface cleaned from printing ink.

Polysiloxanes are hybrid polymers, having a partly inorganic and a partly organic nature. Polysiloxanes comprise a chain and/or reticular structure, which contains chains formed of alternating silica and oxygen atoms, to which organic carbon-based side chains and/or cross-bridges adhere. The polysiloxane coating can be prepared by polymerising a silica compound containing reactive organic radicals, such as silane, either as such or more preferably together with a purely organic reactive component, such as epoxy resin or diol, so that silane forms an inorganic chain or reticular structure in the polymer thus formed, the organic compound being associated with this structure as side chains or cross-bridges cross-linking the structure. The preparation of polysiloxane coatings can be performed by sol gel techniques, in which the partly polymerised reaction mixture still in liquid state is applied on a paper or board substrate, onto which the coating is cured under heat or irradiation. The production of polysiloxane-coated papers and boards has been depicted in greater detail i.a. in U.S. Pat. Nos. 6,200,644 B1 and 6,307,192 B1, which are included in this patent description with this reference.

As appearing from U.S. Pat. Nos. 6,200,644 B1 and 6,307,192 B1 mentioned above, the physical properties of the polysiloxane coating depend on the reacting components participating in polymerisation, and by selecting the appropriate components, the properties of the coating can be controlled focusing either on the organic or on the inorganic direction. Coating properties that can be controlled in this way include i.a. finish, flexibility and strength. However, compared to purely organic polymer-coatings, polysiloxane coatings have the typical features of a highly glossy surface, relative strength and excellent heat resistance. In addition, the resistance of a polysiloxane coating to strong organic solvents without damage is a crucial property in terms of the invention.

Printing inks tat are especially suitable for the invention comprise polymer-coated, pulverous dry toners, which are used for electro-photographic printing. In electro-photographic printing, which has been described in detail i.a. in EP patent application 629930, the printing station comprises a rotating roll, whose surface is electrically charged and on which charges are formed according to digital information changing a latent image, which is developed by applying toner particles with opposed charges to the roll in conformity with the image. The image consisting of particles is then transferred to a paper directed to pass by the roll, and this may take place e.g. in an electric field, which absorbs the toner particles from the roll to the printing surface of the paper. Finally the toner particles are fixed to the printing surface by fusion of the polymer component of the toner under IR irradiation.

The printing surface of the paper or board consisting of polysiloxane in accordance with the invention is perfectly suitable for electro-photographic printing as described above. The surface is smooth and it has beneficial electric properties in terms of toner particle reception, yielding high printing quality. The toner consumption is low owing to the smooth surface, and the printing surface has sufficiently low electric conductivity in order to prevent the toner from spreading, yet high enough to dissipate part of the particle charge from the printing surface, so that the printed products do not adhere to each other under the charge. The low friction coefficient of the polysiloxane coating also contributes to absence of adhesion. The electric properties of the coating are also substantially independent of air humidity, so that high air humidity will not interfere with the printing process by increasing electric conductivity.

Having high heat resistance, a printing surface formed of polysiloxane is advantageous also in terms of toner fixation under IR irradiation. Typical polymers contained in dry toners comprise polymers and styrene-acrylate copolymers, which melt at far lower temperatures than a polysiloxane coating and in which the carboxyl radicals have high affinity with the free functional radicals of the polysiloxane coating. Thus said carrier polymers of the toner have sufficient adhesion to the polysiloxane coating to prevent the print from being removed by scratching, without impairing the printing surface. The print can still be readily removed from the printing surface without traces by solvent cleaning. The cleanability of the printing surface, which has been confirmed by tests in the invention, can be explained by the affinity between the solvent and the toner carrying out the print, this affinity exceeding the corresponding affinity between toner and polysiloxane.

Acetone is a particularly suitable solvent for cleaning a printing surface, and it has been used in the following embodiment examples. Tests have also proved ethyl acetate and methyl, isobutyl ketone to be most operative in the removal of both polyester-based and styrene-acrylate based printing inks.

Owing to its hard surface, polysiloxane has high scratch resistance and wear resistance, and this is an appreciable advantage in continuous use, including repeated printing and cleaning of the surface.

The printed product of the invention resulting from each printing cycle of the printing method described above is characterised by consisting of the paper or board of a polysiloxane coating, with the print formed of the polymer-based toner adhering to the printing surface so as to be removable by an organic solvent without impairing the printing surface. The polysiloxane coating may be applied to one side only of the paper or board, or optionally both sides of the paper or board can be equipped with a polysiloxane coating. With both sides coated, the printed product of the invention can have prints either on one side only or on both sides. In view of cleaning the product by a solvent, for instance, it may be advantageous to provide both the sides with a protective polysiloxane coating, even though print would be required only on one side of the product.

The polysiloxane layer applied directly against the paper or board may have a weight in the range 5 to 30 g/m², preferably 10 to 20 g/m². Such a polysiloxane layer may be provided on one side or on both sides of the paper or board. However, the paper or board can be equipped with an inner heat-resisting layer of polymer, such as polyester, which may be extruded or laminated as a film, and whose weight is e.g. 5 to 50 g/m², the weight of the polysiloxane layer applied on top of this layer being e.g. 1 to 10 g/m². The weight of the fibrous substrate formed of paper or board may vary within a large range; the range may include i.a. papers having a weight of 20 to 130 g/m² and boards having a weight from 130 to 500 g/m².

The invention further comprises the use of a polysiloxane coating formed on a fibrous substrate as a repeatedly used printing surface in electro-photographic printing, the surface being cleaned with an organic print-removing solvent between the printing cycles.

The invention is illuminated with the following examples 1 to 5, which illustrate the preparation of a printing substrate formed of a polysiloxane-coated board. The material obtained in example 5 has been further subjected to electro-photographic test printing and to solvent cleaning of the printing surface.

Preparation of a Printing Substrate

### EXAMPLE 1

24.83 g of methacryloxypropyltrimethoxysilane and 5.35 g of γ glycidoxypropyltrimethoxysilane were mixed together. 9.13 g of 2,2 bis(4-hydroxyphenyl)propane was added to the mixture. The mixture was hydrolysed by adding gradually 1.19 g of 0.1M nitric acid. After approx. one day 2.00 g of silicon dioxide was added to the mixture. After the silicon dioxide had dissolved, 1.04 g of 1-methyl-imidazol was added to the mixture. The board was coated with the mixture within 1 day after the addition of 1-methyl-imidazol. The coating was kept in an oven at 160° C. for two minutes.

### EXAMPLE 2

35.37 g of γ-glycidoxypropyltrimethoxysilane and 9.13 g of 2,2-bis(4-hydroxyphenyl)propane were mixed together. The mixture was hydrolysed by adding gradually 1.78 g of 0.1M nitric acid. After about one day, 2.00 g of silicon oxide was added to the mixture. After the silica dioxide had dissolved, 0.62 g of 1-methyl-imidazol was added to the mixture. The mixture was used for coating a board within one day after the addition of 1-methyl-imidazol. The coating was cured in an oven at 160° C. for two minutes.

### EXAMPLE 3

37.26 g of γ-glycidoxypropylmethyidietoxysilane and 9.13 g of 2,2-bis(4-hydroxyphenyl)propane were mixed together. The mixture was hydrolysed by adding gradually 1.78 g of 0.1M nitric acid. After about one day, 2.00 g of silicon oxide was added to the mixture. After the silicon dioxide had dissolved, 0.62 g of 1-methyl-imidazol was added to the mixture. The mixture was used for coating a board within one day after the addition of 1-methyl-imidazol. The coating was cured in an oven at 160° C. for two minutes.

### EXAMPLE 4

The procedure was the same as in example 3, but with 2,2-bis(4-hydroxyphenyl)propane used in an amount of 13.70 g.

### EXAMPLE 5

The procedure was the same as in example 3, but with 2,2-bis(4-hydroxyphenyl)propane used in an amount of 6.84 g.

Test Prints and Removal of Printing Ink

### EXAMPLE 6

The coated board obtained in example 3, with the weight of the board substrate being 275 g/m² and the weight of the coating approx. 20 g/m², was subjected to electro-photographic printing using a pulverous styrene acrylate-based dry toner, which was fixed to the printing substrate by melting the toner at a temperature of 160° C. The printing surface was subsequently cleaned by removing the printing ink with the aid of acetone.

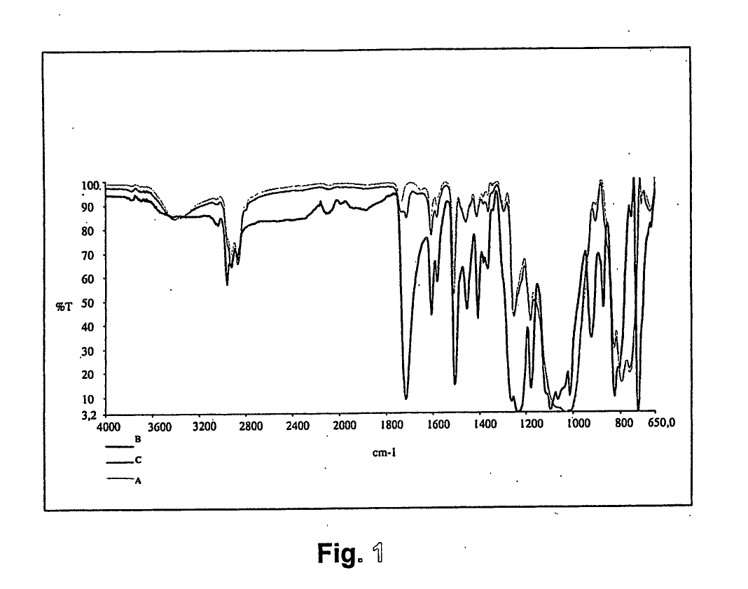

The Fourier Transform Infrared Spectres FTIR of the printing surface shown in FIG. 1 were run before printing (curve A), after printing (curve B), and 15 min. after cleaning with acetone (curve C). Curve B of the printed surface shows marked peaks caused by the styrene acrylate of the toner at wave numbers 1712 cm⁻¹ and 1516 cm⁻¹, which do not appear in curve A of the clean unprinted surface. Curve C of the surface cleaned with acetone is substantially identical to curve A of the unprinted surface, indicating that the toner has been completely removed and that the surface is undamaged.

### EXAMPLE 7

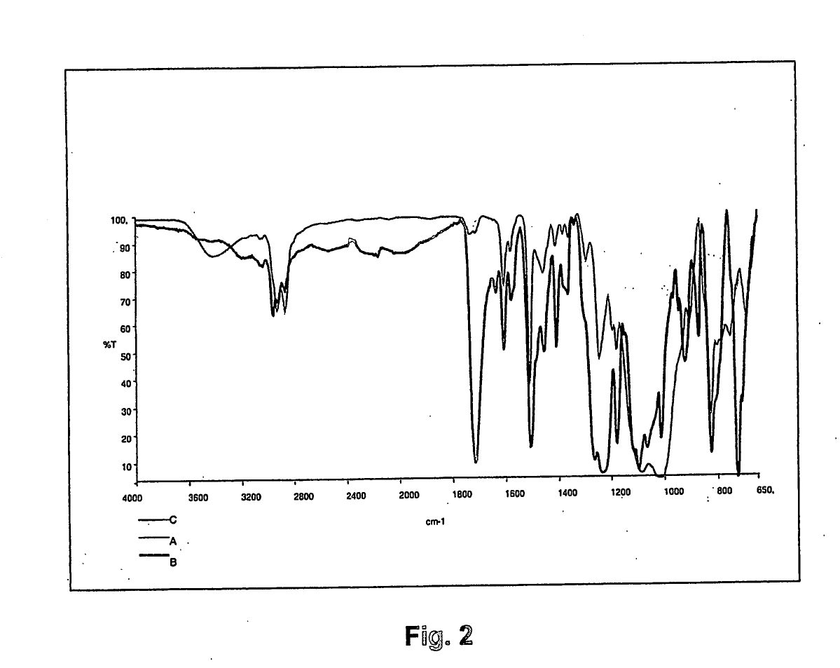

The board obtained in example 3 was printed and subsequently cleaned with acetone as in example 6. The printing surface cleaned with acetone was then printed again in a manner similar to the first print. A run of an FTIR spectre of this repeatedly printed surface was made, the spectre being curve B in accompanying FIG. 2. Finally the printing surface was cleaned again with acetone, and curve C was run as shown in FIG. 2. The run of curve A was made on a clean printing surface before the repeated prints mentioned above. The correlation between curve B and the curve of example 6 relating to a surface printed just once (curve B in FIG. 1), as well as the analogy between curves A and C prove that the printing surface withstands repeated prints and cleaning operations between the prints without changing or losing its print qualities.

1. A method for using a polymer-coated paper or board as a printing substrate, characterised in that a substrate, whose polymeric printing surface is formed of polysiloxane, is repeatedly used by removing with a solvent the printing ink from the surface already once printed and by subsequently reprinting the surface that has been cleaned from printing ink.

2. A method as defined in claim 1, characterised in that printing is performed using a polymer-based dry toner, which is fixed to the printing surface by fusion.

3. A method as defined in claim 2, characterised in that the polymer on which the toner is based is a polyester containing carboxyl radicals or a styrene-acrylate copolymer.

4. A method as defined in claim 2 or 3, characterised in that printing is performed by electro-photographic means by applying toner particles to the printing surface in an electric field.

5. A method as defined in any of the preceding claims claim 1, characterised in that the solvent for removing the printing ink is an organic solvent, such as acetone.

6. A printed product, characterised in being formed of polysiloxane-coated paper or board, to whose printing surface the print formed of a polymer-based toner has attached so as to be removable with an organic solvent without damaging the surface.

7. A printed product as defined in claim 6, characterised in that the polymer on which the toner is based is a polyester or a styrene-acrylate copolymer, which has been fixed to the printing surface formed of polysiloxane by fusion.

8. A printed product as defined in claim 6 or 7, characterised in that the paper or board has been provided on both sides with a polysiloxane coating and in that at least one side comprises prints.

9. Use of a polysiloxane coating formed on a fibrous substrate as a repeatedly used printing surface of electro-photographic prints, the surface being cleaned between prints with an organic solvent for removing the printing ink.
